(19) United States
(12) Patent Application Publication
(10) Pub. No.: US 2026/0126844 A1
(43) Pub. Date: May 7, 2026

(54) SYSTEM ON CHIP POWER MODE MANAGEMENT FOR ORIGINAL EQUIPMENT MANUFACTURERS

(71) Applicant: Infineon Technologies AG, Neubiberg (DE)

(72) Inventors: Venkateswarlu Borra, Oberhaching (DE); Mario Mlynek, München (DE); Adam Opielka, Griesstaett (DE); Lorenzo Marinelli, Frankfurt (DE)

(21) Appl. No.: 18/938,372

(22) Filed: Nov. 6, 2024

(51) Int. Cl. G06F 1/3206; G06F 15/78

(52) U.S. Cl. CPC G06F 1/3206; G06F 15/7807

(57) ABSTRACT

Systems, methods, and circuitries are provided for configuring and executing custom power modes for a system-on-chip (SoC). In one example, an SoC includes a memory and a processor. The memory is configured to store one or more power modes, wherein a power mode comprises a plurality of SoC component settings. At least one of the power modes comprises a custom power mode. The processor is configured to receive a request to switch from a first power mode to a second power mode; access the memory to determine SoC component settings associated with the second power mode; and provide configuration commands to SoC components based on the SoC component settings associated with the second power mode.

### FIELD

The present disclosure relates generally to the field of processors and in particular to a system-on-chip (SoC) that provides different power consumption modes.

### BACKGROUND

SoCs include many components and software related functions that may be capable of operating in different modes with respect to power consumption. Often, higher performance modes will result in higher power consumption whilst power saving modes may limit available functionality.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates relative power consumption amongst multiple SoC power modes.

FIG. 2 illustrates an example SoC, in accordance with various aspects described.

FIG. 3 illustrates an example custom power mode system, in accordance with various aspects described.

FIG. 4 illustrates operation of an example mode validation circuitry, in accordance with various aspects described.

FIG. 5 illustrates operation of an example mode management circuitry, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

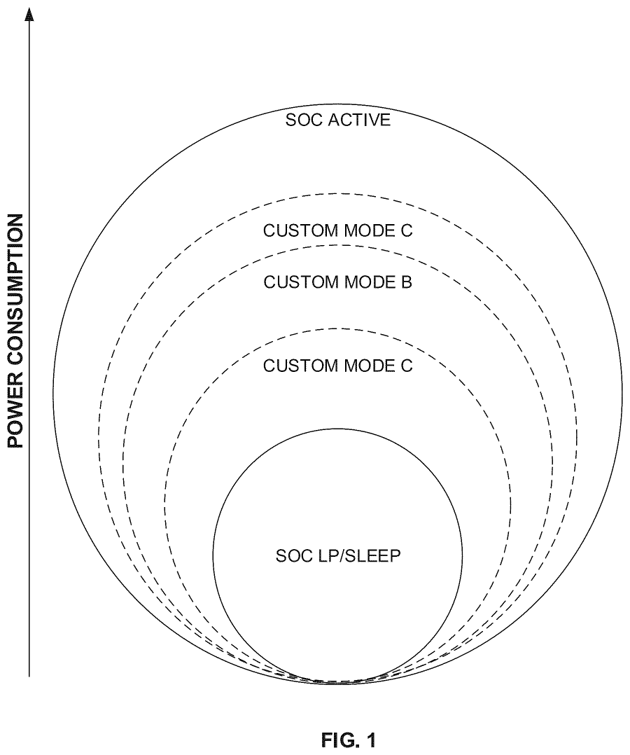

Power management of a system on chip (SoC) is an important key performance indicator in many application contexts, including electric vehicles. With respect to power consumption, SoCs may provide a limited number of standard or default power modes. As indicated by the solid circles in FIG. 1, an example SoC may provide an active mode that consumes a maximum amount of power and exhibits maximum performance and a low power or sleep mode that consumes very little power and supports only minimal SoC functionality. Designers that integrate the SoC into a particular vehicle will install power management software and/or circuitry in the SoC that determines an operating mode of the electric vehicle and triggers or requests the SoC to operate in one of its standard power modes.

Each electric vehicle manufacturer defines its own operating modes like Driving, Charging, On-Grid Parking, Off-Grid Parking, and so on based on certain vehicle operating parameters. When only a few standard power modes are provided by an SoC, a designer may be forced to trigger or request a relatively high power consumption SoC standard mode for a vehicle operating mode that requires just a few active SoC components or that can tolerate lower SoC performance. Thus, it may be desirable for an SoC to provide more standard power modes so that a designer may choose a standard power mode that minimizes power consumption while providing the needed performance for each operating mode. However, providing additional standard power modes for an SoC that meet the needs of multiple manufacturers is not a simple solution. This is because the different operating modes as defined by different manufactures may have different power consumption limitations and performance needs.

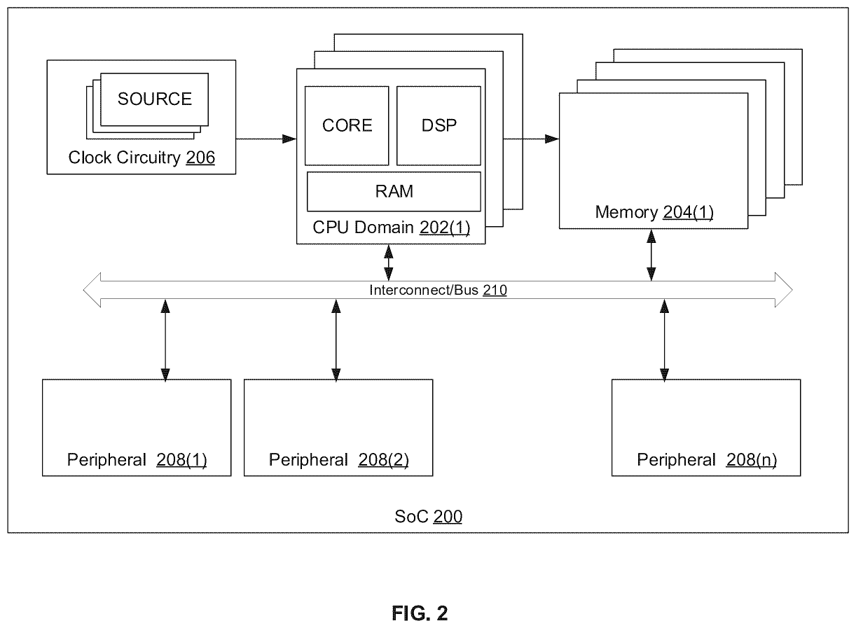

FIG. 2 is a block diagram of an example SoC 200 that illustrates several example SoC components that may be enabled/disabled and/or have multiple modes of operation that may affect the power consumption of the SoC. The SoC components include one or more central processing unit (CPU) domains 202 that each include a set of hardware components such as a CPU core, digital signal processing (DSP) block and dedicated random access memory (RAM). The CPU domains may be independently enabled or disabled. When a CPU domain is disabled, its core, DSP block, and RAM may be powered down or placed in an inactive mode, while retaining current memory state. In addition to the CPU being enabled/disabled, the CPU domains may also be capable of operating in different performance modes (e.g., different DSP functionality may be enable/disabled) in which lower performance is provided but with less power consumption.

The SoC 200 includes memory that is partitioned into multiple partitions or regions 204. Each memory region may be independently enabled/disabled. Clock circuitry 206 provides clock signals to SoC components. The clock circuitry 206 may include multiple clock sources. For example, the clock circuitry 206 may include one or more clock sources dedicated to peripherals, and so on. The frequency of the clock signals provided by each clock source may be selectively ramped up to increase performance or ramped down to save power. Thus, one of several clock signal speeds may be set or configured for each clock source of the clock circuitry 206. The clock circuitry 206 may be arranged in a branch structure through which the clock signal from a given clock source propagates. The branches may be independently enabled/disabled depending on whether SoC components for which the branches provide clock signals are enabled or disabled.

Peripheral components 208 include, for example, a serial peripheral interface (SPI), direct memory access (DMA) controller, and so on, that are shared resources with respect to the different CPU domains. The peripheral components 208 are connected to the CPU domains 202 and memory 204 by an interconnect/bus system 210. Each peripheral component 208 may be independently enabled/disabled and or capable of operating in different performance or power saving modes. In addition to the illustrated SoC components, the SoC may also include several power domains, which are sets of components (e.g., a CPU domain 202 and branch of clock circuitry 206 and a memory region 204) that are grouped together for power management purposes.

It can be seen that there are many SoC components that may be configured in many different ways to affect power consumption. This SoC complexity coupled with the fact that the operating modes of different manufacturers may require different SoC functionality makes it unfeasible to provide a reasonable number of standard power modes that would be satisfactory for use by all manufacturers.

Described herein are systems, methods, and circuitries that provide means for a designer to configure one or more custom power modes for an SoC without having in-depth understanding of SoC components and interactions between SoC components. As illustrated by dashed line circles in FIG. 1, these custom power modes additional power mode options between the standard active and sleep power modes so that the designer is not limited to selecting active mode even when limited SoC performance would be sufficient. The custom power modes may support closer conformance between a given manufacturer's vehicle operating mode's SoC performance needs and the performance provided by the SoC when in a configured custom power mode. This provides additional power consumption reduction capabilities to each manufacturer that configures custom power modes for the SoC. While some examples in this disclosure are related to application of custom power modes in an electric vehicle application, it is to be understood that the disclosed solutions may also be applied in any application in which an SoC is called on to operate in multiple power modes.

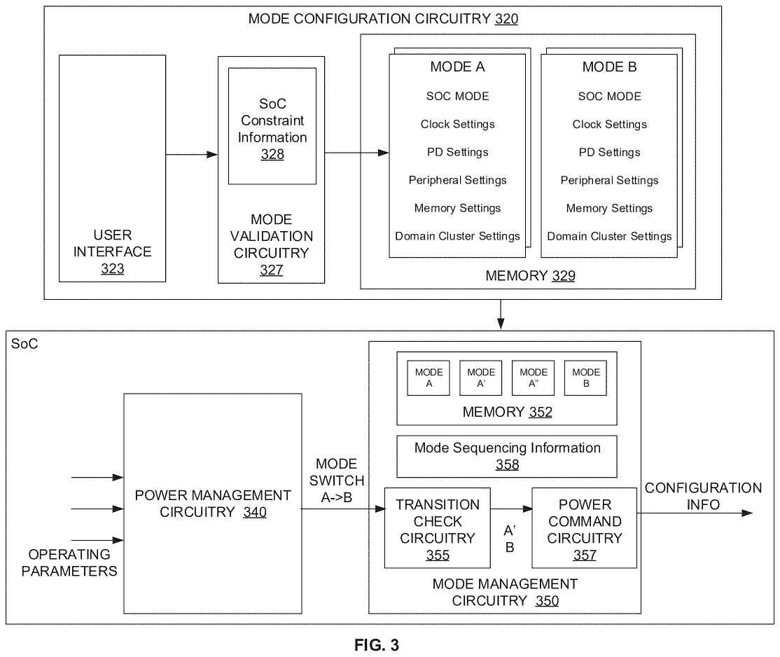

OEM designers may not have detailed understanding of the SoC architecture, components, and the interactions between components. FIG. 3 illustrates an example custom power mode system that provides several features to enable the configuration and execution of custom power modes without in depth knowledge of the SoC architecture. The system includes aspects that may be implemented in separate devices such as a computer and an SoC. In the illustrated example, mode configuration circuitry 320 is implemented on a configuration device, such as a computer, that is used by a designer to configure custom power modes for one or more production lots of SoCs. Power management circuitry 340, mode management circuitry 350 may be implemented in the individual SoC. In some examples, functions illustrated as being performed by the mode configuration circuitry 320 may be performed by the mode management circuitry 350, and vice versa.

Mode configuration circuitry 320 includes a user interface 323 that provides means for a designer to enter values for one or more SoC component settings to generate a custom power mode for the SoC. The user interface 323 may prompt a user to input settings for SoC components. The component settings may be enable/disable or ON/OFF type or scaling or other multi-level type setting (e.g., low/medium/high, and so on). In some examples, the user interface provides prompts or queries that allow a user to configure settings for clock circuitry (e.g., clock speed or branch enable/disable), power domain setting (e.g., enable/disable), peripheral settings (e.g., enable/disable or peripheral-specific power mode level), memory region enable/disable, and/or domain cluster settings (e.g., CPU ON/OFF, DSP performance level, and so on).

Before the custom power mode configuration is completed, mode validation circuitry 327 verifies the input SoC components settings by performing a validity check on the SoC component settings that have been entered for the custom power mode. The mode validation circuitry 327 accesses SoC constraint information 328 that defines prohibited combinations of SoC component settings. For example, if a certain peripheral needs a certain minimum clock speed, the mode validation circuitry 327 will check the clock speed in the custom power mode configuration against the enabled peripheral clock requirements and reject the custom power mode configuration if the configured clock speed is too low for an enabled peripheral. As another example, if a certain memory is set to ON for a custom mode, the mode validation circuitry 327 will prevent or flag as an error the disabling of a power domain that includes the memory.

In some examples, the mode validation circuitry 327 prevents the user interface from accepting prohibited combinations of SoC component settings rather than waiting to perform the validation check until after the configuration is completed. Once a custom power mode has been validated, it may be stored in memory 329 until being exported, for example, as a configuration file to memory 352 of the SoC.

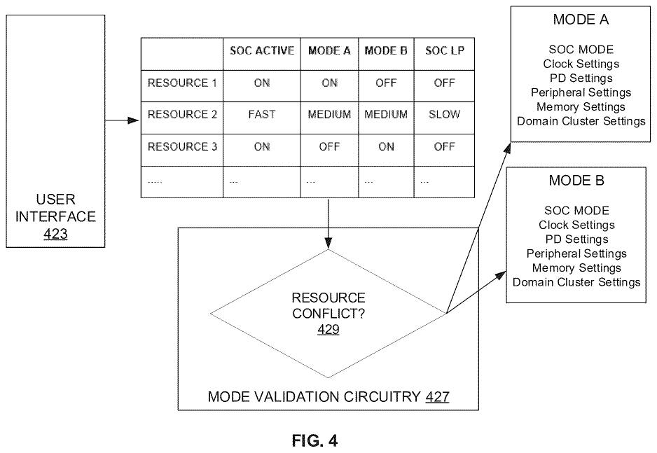

FIG. 4 illustrates operation of an example mode validation circuitry 427. User interface 423 is used to populate two different custom modes A and B. For custom power mode A, the mode validation circuitry 427 performs a resource conflict check 429 to check whether resource 1, which is configured to ON can operate properly when resource 2 is set to MEDIUM (e.g., a clock speed) and resource 3 (e.g., a certain memory region) is disabled or OFF. This check is performed based on stored SoC constraint information. If the SoC constraints defined by the stored constraint information are not violated the SoC component settings input by the designer via the user interface 423 may be converted (e.g., by mode configuration circuitry 320 of FIG. 3) into hardware related configuration settings and header files that may be used when the custom power mode is called for in SoC operation. Similarly mode validation circuitry 427 performs the resource conflict check 429 on custom power mode B and if the stored SoC constraints are met, hardware related configuration settings and header files are generated for custom power mode B.

Returning to FIG. 3, power management circuitry 340 maps SoC power modes to certain combinations of operating parameters. At runtime, power management circuitry 340 monitors various vehicle operating parameters (e.g., speed, gear selection, ignition position, charging system status, and so on). Based on the monitored parameters, the power management circuitry 340 determines a current operating status of the vehicle. Each operating status is mapped to an SoC power mode. When the determined operating status is mapped to an SoC power mode (e.g., custom power mode B) different from the current SoC power mode (e.g., custom power mode A), the power management circuitry 340 requests a power mode switch to the desired SoC power mode.

The mode management circuitry 350 receives the request for the power mode switch to custom power mode B. In some examples, the mode management circuitry includes an application specific interface (API) that allows the power management circuitry 340 to request a transition between configured power modes.

Transition check circuitry 355 accesses mode sequencing information 358 to determine a sequence of SoC power mode states that effectuate the requested power mode switch while avoiding risks to SoC integrity. The mode sequencing information 358 may capture SoC component characteristics and interdependencies between various SoC components. For example, if the transition to custom power mode B includes disabling a CPU domain and a certain peripheral, the SoC may first operate in an intermediate power mode A′ in which the CPU domain is switched to OFF and then enter the requested power mode in which the peripheral is disabled. This allows the peripheral to complete transactions related to the CPU domain and avoid error conditions. Thus, the transition check circuitry 355 may control the transition between power modes by placing the SoC in one or more intermediate power modes prior to entering the requested SoC power mode. The intermediate power mode is indicated as A′ in FIG. 3. More than one intermediate power mode may be entered when transitioning between custom power modes.

It is noted that the intermediate power modes and the sequence of intermediate power modes that are mapped to the transition between two configured SoC power modes (e.g., custom or default power modes) are transparent to the OEM designer. The OEM designer configuring custom power modes does not need to have knowledge of the different constraints and ordering of SoC component power modes needed to transition between different configured custom power modes.

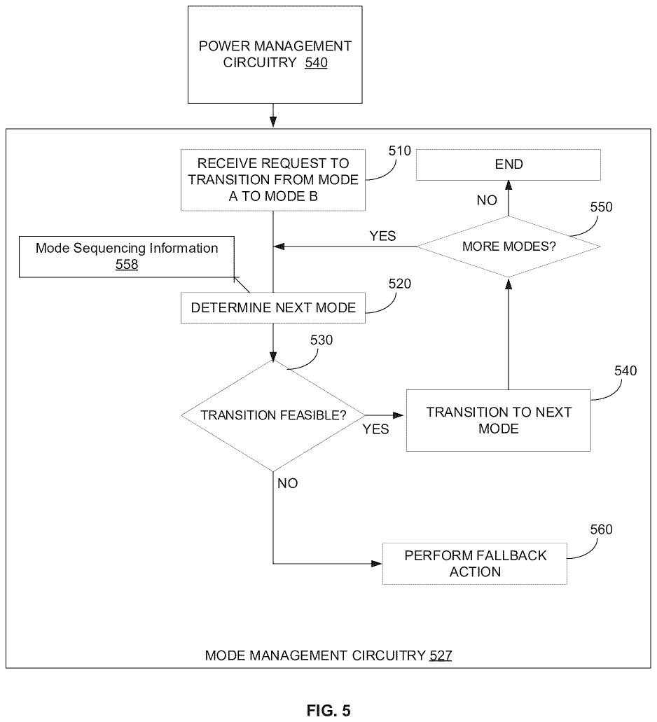

In addition to determining the sequence of intermediate SoC component configuration states, the transition check circuitry 355 determines the feasibility for each intermediate SoC component configuration states as well as the requested SoC power mode based on current operating conditions as described with reference to FIG. 5.

When the transition to the next intermediate SoC power mode or the requested SoC power mode has been determined to be feasible, power command circuitry 357 outputs configuration information that deploys the settings of the power mode on the SoC.

FIG. 5 illustrates operation of example mode management circuitry 527. At 510 a request is received to transition from custom power mode A to custom power mode B. At 520 a next power mode (either an intermediate power mode, such as A′, or the requested power mode B) is determined based on mode sequencing information 558. At 530, the transition to the next power mode is verified to determine if the transition is feasible. If the transition is not feasible, a fallback action is performed at 560.

When the transition is determined to be feasible at 530, the transition to the next power mode is performed at 540. The transition may be performed by retrieving stored SoC component settings mapped to the next power mode (e.g., in state sequencing information or memory). The relevant SoC component configuration settings for each power mode may be passed as an argument by way of a generic interface having all settings for the SoC components configured to mode. The currently configured settings for the SoC components will thereby be overwritten with new settings through the generic interface. Successive transitions to a next power mode are performed until, at 550, it is determined that the present power mode is the requested power mode (e.g., mode B). Actions 520, 530, 550, and 560 may be performed by transition check circuitry 355 of FIG. 3. Action 540 may be performed by power command circuitry 357 of FIG. 3.

It can be seen that providing mode configuration circuitry to allow for the configuration of custom power modes and mode management circuitry to execute SoC configuration according to the custom power modes may allow for closer conformance between power consumption required by operating conditions and the power consumption of the power mode of the SoC.

Above are several flow diagrams outlining example methods. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

As used herein, the term provide when used with reference to information or data or a signal encoding data is to be construed broadly as encompassing any manner of communicating the information, data, or signal encoding data either explicitly or implicitly. “Provide” should be construed to encompass transmitting a message that indicates the information or data, storing the information or data in memory accessible to the recipient of the providing, controlling electrical signals on conductors in a circuit to encode the information or data, and so on.

As used herein, the term obtain when used with reference to information or data or a signal encoding data is to be construed broadly as encompassing any manner of receiving the information, data, or signal encoding data either explicitly or implicitly. “Obtain” should be construed to encompass receiving a message that indicates the information or data, reading the information or data from memory, performing computations or processing on other data to obtain the information or data, detecting electrical signals on conductors in a circuit detect the information or data, and so on.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to provide safety management on a per-application group basis according to embodiments and examples described herein.

### Examples

Example 1 is a custom power mode configuration system, including memory and a processor, configured to obtain configuration of a custom power mode, wherein the configuration includes a plurality of SoC component settings; determine whether the plurality of SoC component settings of the custom power mode violates a constraint; and when the plurality of SoC component settings does not violate a constraint, store the custom power mode in the memory.
Example 2 includes the subject matter of claim 1, including or omitting optional elements, wherein the constraint defines SoC component settings or combinations of SoC component settings that are prohibited.
Example 3 includes the subject matter of claim 1, including or omitting optional elements, wherein the plurality of SoC components include one or more of clock circuitry, central processing unit (CPU), memory region, a power domain including a set of SoC components, or a peripheral component.
Example 4 includes the subject matter of claim 1, including or omitting optional elements, wherein the memory is configured to store, for each custom power mode, a plurality of configuration files associated with respective SoC components, wherein the configuration file for a given SoC component defines values for SoC component settings of the given SoC component.
Example 5 is a system-on-chip (SoC), including a memory configured to store one or more power modes, wherein a power mode includes a plurality of SoC component settings, further wherein at least one of the power modes includes a custom power mode and a processor, configured to receive a request to switch from a first power mode to a second power mode; access the memory to determine SoC component settings associated with the second power mode; and provide configuration commands to SoC components based on the SoC component settings associated with the second power mode.
Example 6 includes the subject matter of claim 5, including or omitting optional elements, wherein the processor is further configured to verify that the SoC component settings of the second power mode are feasible; and perform a fallback action when any of the SoC component settings of the second power mode are note feasible.
Example 7 includes the subject matter of claim 5, including or omitting optional elements, wherein the processor is further configured to determine an intermediate power mode including a plurality of SoC component settings associated with the switch from the first power mode to the second power mode; and provide configuration commands to SoC components based on the intermediate power mode prior to providing the configuration commands to the SoC components based on the SoC component settings of the second power mode.
Example 8 includes the subject matter of claim 7, including or omitting optional elements, wherein the processor is further configured to verify that the SoC component settings of the intermediate power mode are feasible; perform a fallback action when any of the SoC component settings of the intermediate power mode are not feasible; once in the intermediate power mode, verify that the SoC component settings of the second power mode are feasible; and perform a fallback action when any of the SoC component settings of the second power mode are not feasible.
Example 9 includes the subject matter of claim 5, including or omitting optional elements, wherein the SoC components include one or more of clock circuitry, central processing unit (CPU), memory region, a power domain including a set of SoC components, or a peripheral component.
Example 10 includes the subject matter of claim 5, including or omitting optional elements, wherein the memory is configured to store, for each custom power mode, a plurality of configuration files associated with respective SoC components, wherein the configuration file for a given SoC component defines values for SoC component settings of the given SoC component.
Example 11 is a method, including providing configuration information defining one or more power modes, wherein a power mode includes a plurality of SoC component settings, further wherein at least one of the power modes includes a custom power mode; receiving a request to switch from a first power mode to a second power mode; determining SoC component settings associated with the second power mode based on the configuration information defining the second power mode; and providing configuration commands to SoC components based on the determined SoC component settings.
Example 12 includes the subject matter of claim 11, including or omitting optional elements, further including verifying that the SoC component settings of the second power mode are feasible; and performing a fallback action when any of the SoC component settings of the second power mode are note feasible.
Example 13 includes the subject matter of claim 11, including or omitting optional elements, further including determining an intermediate power mode associated with the switch from the first power mode to the second power mode; and providing intermediate configuration commands to SoC components based on the intermediate power mode prior to providing the configuration commands to the SoC components based on the SoC component settings of the second power mode.
Example 14 includes the subject matter of claim 13, including or omitting optional elements, further including verifying that SoC component settings of the intermediate power mode are feasible; performing a fallback action when any of the SoC component settings of the intermediate power mode are not feasible; once in the intermediate power mode, verifying that the SoC component settings of the second power mode are feasible; and performing a fallback action when any of the SoC component settings of the second power mode are not feasible.
Example 15 includes the subject matter of claim 11, including or omitting optional elements, wherein the SoC components include one or more of clock circuitry, central processing unit (CPU), memory region, a power domain including a set of SoC components, or a peripheral component.
Example 16 includes the subject matter of claim 11, including or omitting optional elements, wherein the configuration information includes configuration files associated with respective SoC components, wherein the configuration file for a given SoC component defines values for SoC component settings of the given SoC component.
Example 17 includes the subject matter of claim 11, including or omitting optional elements, further including compiling the configuration information by obtaining configuration of a custom power mode, wherein a custom power mode includes a plurality of SoC component settings; determining whether the plurality of SoC component settings of the custom power mode violates a constraint; and when the plurality of SoC component settings does not violate a constraint, storing the custom power mode in a memory.
Example 18 includes the subject matter of claim 17, including or omitting optional elements, wherein the constraint defines SoC component settings or combinations of SoC component settings that are prohibited.
Example 19 includes the subject matter of claim 17, including or omitting optional elements, including storing, for each custom power mode, a plurality of configuration files associated with respective SoC components, wherein the configuration file for a given SoC component defines values for SoC component settings of the given SoC component.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. A custom power mode configuration system, comprising:
a memory; and
a processor, configured to
obtain configuration of a custom power mode, wherein the configuration comprises a plurality of SoC component settings;
determine whether the plurality of SoC component settings of the custom power mode violates a constraint; and
when the plurality of SoC component settings does not violate a constraint, store the custom power mode in the memory.

2. The custom power mode configuration system of claim 1, wherein the constraint defines SoC component settings or combinations of SoC component settings that are prohibited.

3. The custom power mode configuration system of claim 1, wherein the plurality of SoC components comprise one or more of clock circuitry, central processing unit (CPU), memory region, a power domain comprising a set of SoC components, or a peripheral component.

4. The custom power mode configuration system of claim 1, wherein the memory is configured to store, for each custom power mode, a plurality of configuration files associated with respective SoC components, wherein the configuration file for a given SoC component defines values for SoC component settings of the given SoC component.

5. A system-on-chip (SoC), comprising:
a memory configured to store one or more power modes, wherein a power mode comprises a plurality of SoC component settings, further wherein at least one of the power modes comprises a custom power mode; and
a processor, configured to
receive a request to switch from a first power mode to a second power mode;
access the memory to determine SoC component settings associated with the second power mode; and
provide configuration commands to SoC components based on the SoC component settings associated with the second power mode.

6. The SoC of claim 5, wherein the processor is further configured to
verify that the SoC component settings of the second power mode are feasible; and
perform a fallback action when any of the SoC component settings of the second power mode are note feasible.

7. The SoC of claim 5, wherein the processor is further configured to
determine an intermediate power mode comprising a plurality of SoC component settings associated with the switch from the first power mode to the second power mode; and
provide configuration commands to SoC components based on the intermediate power mode prior to providing the configuration commands to the SoC components based on the SoC component settings of the second power mode.

8. The SoC of claim 7, wherein the processor is further configured to
verify that the SoC component settings of the intermediate power mode are feasible;
perform a fallback action when any of the SoC component settings of the intermediate power mode are not feasible;
once in the intermediate power mode, verify that the SoC component settings of the second power mode are feasible; and
perform a fallback action when any of the SoC component settings of the second power mode are not feasible.

9. The SoC of claim 5, wherein the SoC components comprise one or more of clock circuitry, central processing unit (CPU), memory region, a power domain comprising a set of SoC components, or a peripheral component.

10. The SoC of claim 5, wherein the memory is configured to store, for each custom power mode, a plurality of configuration files associated with respective SoC components, wherein the configuration file for a given SoC component defines values for SoC component settings of the given SoC component.

11. A method, comprising
providing configuration information defining one or more power modes, wherein a power mode comprises a plurality of SoC component settings, further wherein at least one of the power modes comprises a custom power mode;
receiving a request to switch from a first power mode to a second power mode;
determining SoC component settings associated with the second power mode based on the configuration information defining the second power mode; and
providing configuration commands to SoC components based on the determined SoC component settings.

12. The method of claim 11, further comprising
verifying that the SoC component settings of the second power mode are feasible; and
performing a fallback action when any of the SoC component settings of the second power mode are note feasible.

13. The method of claim 11, further comprising
determining an intermediate power mode associated with the switch from the first power mode to the second power mode; and
providing intermediate configuration commands to SoC components based on the intermediate power mode prior to providing the configuration commands to the SoC components based on the SoC component settings of the second power mode.

14. The method of claim 13, further comprising
verifying that SoC component settings of the intermediate power mode are feasible;
performing a fallback action when any of the SoC component settings of the intermediate power mode are not feasible;
once in the intermediate power mode, verifying that the SoC component settings of the second power mode are feasible; and
performing a fallback action when any of the SoC component settings of the second power mode are not feasible.

15. The method of claim 11, wherein the SoC components comprise one or more of clock circuitry, central processing unit (CPU), memory region, a power domain comprising a set of SoC components, or a peripheral component.

16. The method of claim 11, wherein the configuration information comprises configuration files associated with respective SoC components, wherein the configuration file for a given SoC component defines values for SoC component settings of the given SoC component.

17. The method of claim 11, further comprising compiling the configuration information by
obtaining configuration of a custom power mode, wherein a custom power mode comprises a plurality of SoC component settings;
determining whether the plurality of SoC component settings of the custom power mode violates a constraint; and
when the plurality of SoC component settings does not violate a constraint, storing the custom power mode in a memory.

18. The method of claim 17, wherein the constraint defines SoC component settings or combinations of SoC component settings that are prohibited.

19. The method of claim 17, comprising storing, for each custom power mode, a plurality of configuration files associated with respective SoC components, wherein the configuration file for a given SoC component defines values for SoC component settings of the given SoC component.
